(19) United States
(12) Patent Application Publication
(10) Pub. No.: US 2025/0008931 A1
(43) Pub. Date: Jan. 9, 2025

(54) Poultry Water Feeder

(71) Applicant: Dexing Meng, Dezhou (CN)

(72) Inventor: Dexing Meng, Dezhou (CN)

(21) Appl. No.: 18/218,879

(22) Filed: Jul. 6, 2023

(51) Int. Cl. A01K 39/026

(52) U.S. Cl. CPC A01K 39/026

(57) ABSTRACT

The utility model relates to a poultry water feeder, which belongs to the technical field of a drinking bowl for breeding. The poultry water feeder comprises a water tray and a water storage device on which the water tray is removably installed, wherein a water trough is arranged on the water tray, a water inlet is arranged on the water storage device, and the water storage device comprises a bucket body and a bucket bottom cover, a water outlet hole connected with the water trough is arranged on the bucket bottom cover, and the poultry water feeder also comprises a sealing component, one part of which is arranged on the bucket bottom cover and the other part of which is arranged on the water tray for opening or sealing the water outlet hole. The technical proposal has the following advantages: by arranging the sealing component, the water tray is not required to be turned upside down at the bottom of the water storage device when the water storage device is filled with water, so that water added to the water feeder is more hygienic, thereby preventing the pollutants on the water tray from falling to the hands or the ground due to the reversal of the water tray and making it easy for the user to clean the water tray without water waste in the water storage device.

### TECHNICAL FIELD

The utility model relates to the technical field of a drinking bowl for breeding, in particular to a poultry water feeder.

### BACKGROUND ART

The poultry drinking bowl (water feeder) is used for the poultry to drink water in the poultry breeding process. The common poultry drinking bowl is mainly composed of a water storage box and a water tray, and the drinking water in the storage box flows into the water tray for the poultry to drink. At present, when the common poultry drinking bowls are filled with water, it is necessary to first turn the water storage box upside down, inject the drinking water from the bottom of the water storage box into the water storage box, fill the water storage box, and then turn the water tray upside down at the bottom of the water storage box, and finally invert the drinking bowl. Because the drinking bowl is placed in the breeding farm, some feces may stick to the bottom of the water tray during use, and the hands or the ground is easily contaminated during the installation of the water tray on the water storage box. Therefore, the common poultry drinking bowls need to be improved.

### Content of Utility Model

The utility model provides a poultry water feeder which is designed in light of the defects and deficiencies of the prior art. By arranging the sealing component, the water tray is not required to be turned upside down at the bottom of the water storage device when the water storage device is filled with water, so that water added to the water feeder is more hygienic, thereby preventing the pollutants on the water tray from falling to the hands or the ground due to the reversal of the water tray and making it easy for the user to clean the water tray without water waste in the water storage device.

To this end, the utility model adopts the following technical proposal: an poultry water feeder comprises a water tray and a water storage device on which the water tray is removably installed, wherein a water trough is arranged on the water tray, a water inlet is arranged on the water storage device, and the water storage device comprises a bucket body and a bucket bottom cover, a water outlet hole connected with the water trough is arranged on the bucket bottom cover, and the poultry water feeder also comprises a sealing component, one part of which is arranged on the bucket bottom cover and the other part of which is arranged on the water tray for opening or sealing the water outlet hole.

A water guide slot connected with the water outlet hole and the water trough is arranged under the water outlet hole of the water tray, the sealing component comprises a plugging part arranged at the bottom of the bucket bottom cover, located at the bottom of the water outlet hole and capable of being plugged in the water guide slot, a movable rod arranged in a movable hole and with one end extending into the water outlet hole, a seal located on the top of the movable rod and used for sealing with or separating from the water outlet hole under the drive of the movable rod, a propping part arranged in the water guide slot and capable of propping against the movable rod to separate the seal from the water outlet hole, and an elastic part arranged in the movable hole and with both ends connected with the bottom of the movable rod and the bottom of the bucket bottom cover respectively, and the movable hole connected with the water outlet hole is arranged on the plugging part.

A limit part is arranged on the top of the water outlet hole of the bucket bottom cover, a water outlet connected with the water outlet hole and capable of sealing with or separating from the outer side wall of the seal is arranged on the limit part, a plurality of limit rods are arranged between the water outlet and the movable hole on the bucket bottom cover, and a through hole connected with the water outlet and the movable hole is arranged between the two adjacent limit rods.

A limit head with a diameter greater than that of the water outlet hole is arranged at one end of the movable rod away from the water outlet hole, the elastic part is sleeved on the movable rod, and both ends thereof are respectively propped against the limit rod and the limit head.

A base is integrally arranged in the water trough on the water tray, the water trough arranged between the base and the inner side wall of the water tray is circular, and the water guide slot is arranged on the base.

A plurality of plugging columns protrude downward at the bottom of the bottom cover, and a plurality of plugging slots used for the plugging columns to be plugged one by one are arranged on the base.

A first clamping part is arranged on the outer side wall of the bucket body near the bucket bottom cover, a second clamping part capable of being clamped with the first clamping part is arranged on the inner side wall of the bucket bottom cover, and a sealing sleeve for sealing the bucket body and the bucket bottom cover is sleeved on the edge of the bottom opening of the bucket body.

The water inlet is arranged on the top of the bucket body, and the poultry water feeder also comprises a cover body covered on the water inlet.

The cover body is connected with water inlet through a thread, and a sealing gasket is arranged between the cover body and the water inlet.

A plurality of supporting legs capable of adjusting the height of the water tray are arranged at the bottom of the water tray at intervals.

After adopting the technical proposal, the utility model has the following advantages: a poultry water feeder comprises a water tray, a water storage device and a sealing component. The water storage device and the water tray are removably assembled, a water trough is arranged on the water tray, a water inlet is arranged on the water storage device, the water storage device comprises a bucket body and a bucket bottom cover, a water outlet hole connected with the water trough is arranged on the bucket bottom cover, one part of the sealing component is arranged on the bucket bottom cover and the other part thereof is arranged on the water tray, and the sealing component is used for opening or sealing the water outlet hole. In some embodiments, the bucket body and the bucket bottom cover are removably assembled; in some embodiments, the bucket body and the bucket bottom cover are formed into a whole. When the bucket bottom cover is assembled with the water tray, the sealing component opens the water outlet hole under the drive of the bucket bottom cover, and seals the water outlet hole under the drive of the restoring force when the bucket bottom cover is separated from the water tray. By arranging the sealing component, the water tray is not required to be turned upside down at the bottom of the water storage device when the water storage device is filled with water, so that water added to the water feeder is more hygienic, thereby preventing the pollutants on the water tray from falling to the hands or the ground due to the reversal of the water tray and making it easy for the user to clean the water tray without water waste in the water storage device.

To make it easy for the user to fill water, the water inlet is arranged on the top of the bucket body, so that the user fills water into the water feeder without removal of the water storage device from the water tray, just fill water directly into the water inlet, making filling more convenient, and reducing the output of the physical strength; the poultry water feeder also comprises a cover body covered on the water inlet to prevent external dust from entering into the bucket body through the water inlet.

### DESCRIPTION OF DRAWINGS

To more clearly describe the embodiments of the utility model or the technical proposal of the prior art, the drawings required for the description of the embodiments or the prior art are briefly introduced. Obviously, the drawings below are only for some embodiments of the utility model. The ordinary technicians in the field can also obtain other drawings from these drawings without creative labor.

FIG. 1 is the structure diagram for the supporting legs of the utility model in the folding state;

FIG. 2 is the structure diagram for the supporting legs of the utility model in the unfolding state;

FIG. 3 is the section view of the utility model;

FIG. 4 is the explosive view of the utility model;

FIG. 5 is the explosive view of the utility model in another direction;

FIG. 6 is the explosive view for the bucket bottom cover of the utility model.

Description of reference signs in the drawings: 1. Water tray; 2. Water storage device; 3. Sealing component; a. Water trough; b. Water inlet; 21. Bucket body; 22. Bucket bottom cover; c. Water outlet hole; d. Water guide slot; 31. Plugging part; 32. Movable rod; 33. Seal; 34. Propping part; 35. Elastic part; e. Movable hole; 221. Limit part; 222. Limit rod; f. Water outlet; g. Through hole; 321. Limit head; 223. Plugging column; h. Plugging slot; 211. First clamping part; 224. Second clamping part; 23. Sealing sleeve; 4. Cover body; 24. Water inlet part; 5. Sealing gasket; 6. Supporting leg; i. Assembly groove; 61. Assembly part; 62. First supporting leg; 63. Second supporting leg; 611. Limit bump; 225. Base.

### EMBODIMENTS

The utility model is further described in detail in combination with the drawings.

The embodiment is only the interpretation of the utility model, but not a limitation to the utility model. The technicians in the field can make modifications without creative contributions to the embodiment as required after reading the specification, and such modifications within the scope of the claims of the utility model are protected by the patent law.

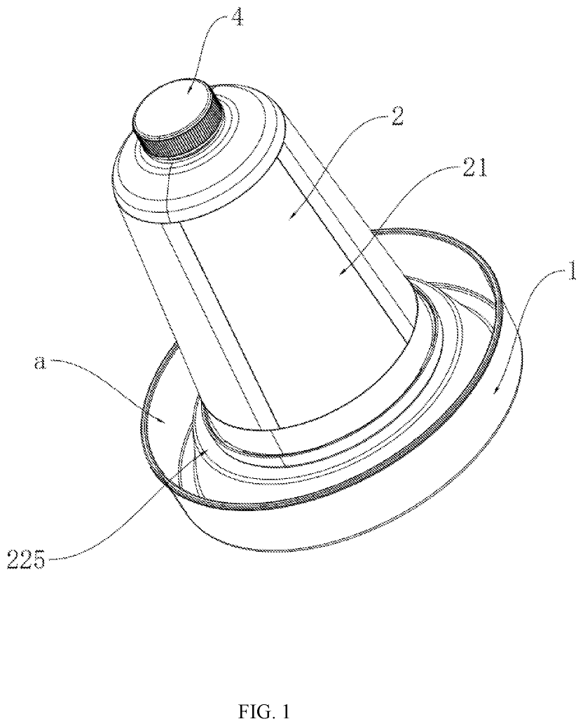

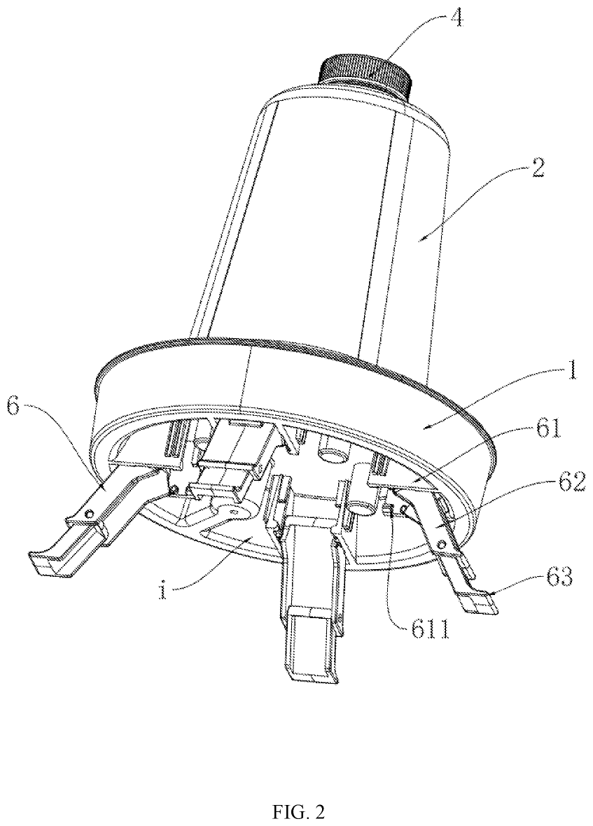

The embodiment relates to a poultry water feeder, which comprises a water tray 1, a water storage device 2 and a sealing component 3, as shown in FIG. 1 to FIG. 3.

The water storage device 2 and the water tray 1 are removably assembled, a water trough a is arranged on the water tray 1, a water inlet b is arranged on the water storage device 2, the water storage device 2 comprises a bucket body 21 and a bucket bottom cover 22, a water outlet hole c connected with the water trough a is arranged on the bucket bottom cover 22, one part of the sealing component 3 is arranged on the bucket bottom cover 22 and the other part thereof is arranged on the water tray 1, and the sealing component 3 is used for opening or sealing the water outlet hole c. In some embodiments, the bucket body 21 and the bucket bottom cover 22 are removably assembled; in some embodiments, the bucket body 21 and the bucket bottom cover 22 are formed into a whole.

It should be noted that when the bucket bottom cover 22 is assembled with the water tray 1, the sealing component 3 opens the water outlet hole c under the drive of the bucket bottom cover 22, and seals the water outlet hole c under the drive of the restoring force when the bucket bottom cover 22 is separated from the water tray 1. By arranging the sealing component 3, the water tray 1 is not required to be turned upside down at the bottom of the water storage device 2 when the water storage device 2 is filled with water, so that water added to the water feeder is more hygienic, thereby preventing the pollutants on the water tray 1 from falling to the hands or the ground due to the reversal of the water tray 1 and facilitating the user to clean the water tray 1 without water waste in the water storage device 2.

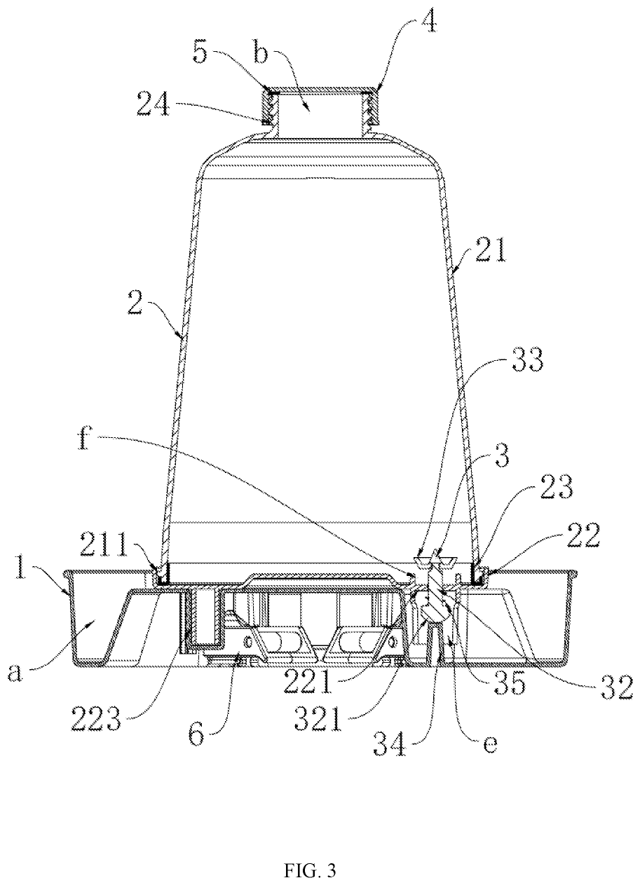

Preferably, to realize the function of the sealing component 3 to open or seal the water outlet hole c, as shown in FIG. 3 to FIG. 5, a water guide slot d connected with the water outlet hole c and the water trough a is arranged under the water outlet hole c of the water tray 1, and the sealing component 3 comprises a plugging part 31, a movable rod 32, a seal 33, a propping part 34 and an elastic part 35. The plugging part 31 is arranged at the bottom of the bucket bottom cover 22, is located at the bottom of the water outlet hole c and is capable of being plugged in the water guide slot d, and the plugging part 31 protrudes downward at the bottom of the bucket bottom cover 22. A movable hole e connected with the water outlet hole c is arranged on the plugging part 31. The movable rod 32 is arranged in the movable hole e, and one end thereof extends into the water outlet hole c. The seal 33 is located on the top of the movable rod 32, is fixed with the movable rod 32 by injection molding or forms interference fit with the movable rod 32. The seal 33 is used to seal with or separate from the water outlet hole c under the drive of the movable rod 32. The diameter of the movable rod 32 is less than that of the water outlet hole c, the diameter of the movable hole e is greater than that of the water outlet hole C, and the propping part 34 is arranged in the water guide slot d and can be propped against the bottom of the movable rod 32 to separate the seal 33 from the water outlet hole c. The propping part 34 protrudes upward at the bottom of the water guide slot d, and the elastic part 35 is arranged in the movable hole e, and both ends thereof are connected with the bottom of the movable rod 32 and the bottom of the bucket bottom cover 22 respectively. The elastic part 35 can be a spring, elastic piece or elastic block. In the embodiment, a slot connected with movable hole e and the water guide slot d is arranged on the side wall of the plugging part 31, so that the water of the bucket body 21 enters the water trough a through the water outlet hole c, the movable hole e, the slot and the water guide slot d for the poultry to drink. In other embodiments, the length of the plugging part 31 is less than the depth of the water guide slot d.

It should be noted that when the plugging part 31 at the bottom of the water storage device 2 is plugged into the water guide slot d, and the top of the propping part 34 is in contact with the bottom of the movable rod 32 and continues to move downward, the propping part 34 pushes the movable rod 32 upward to move upward in the movable hole e, so that the seal 33 moves upward under the drive of the movable rod 32 to open the water outlet hole c; when the plugging part 31 is separated from the water guide slot d, the movable rod 32 moves downward under the restoring force of the elastic part 35, so that the seal 33 moves downward under the drive of the movable rod 32 to seal the water outlet hole c. The arrangement of the plugging part 31 and the water guide slot d is the assembly positioning between the water storage device 2 and the water tray 1, so that the water storage device 2 is stably installed on the water tray 1, and the water in the bucket body 21 easily enters the water trough a when the seal 33 and the water outlet hole c are open.

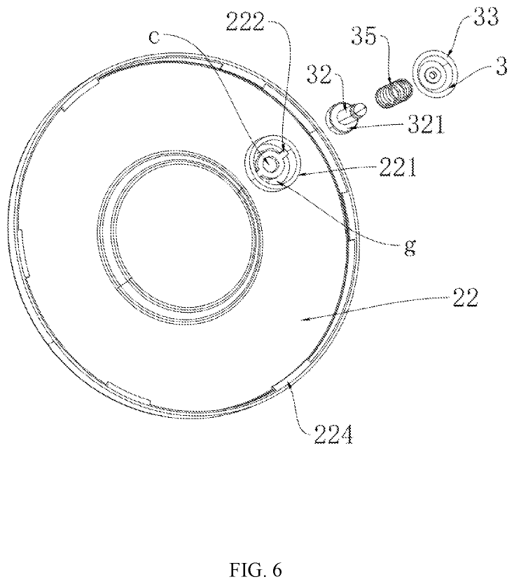

Optionally, to prevent the seal 33 from entering the water outlet hole c excessively, as shown in FIG. 3 to FIG. 6, a limit part 221 is arranged on the top of the water outlet hole c of the bucket bottom cover 22, a water outlet f connected with the water outlet hole c and capable of sealing with or separating from the outer side wall of the seal 33 is arranged on the limit part 221, a plurality of limit rods 222 are arranged between the water outlet f and the movable hole e on the bucket bottom cover 22, and a through hole g connected with the water outlet f and the movable hole e is arranged between the two adjacent limit rods 222. A limit head 321 with a diameter greater than that of the water outlet hole c is arranged at one end of the movable rod 32 away from the water outlet hole c to prevent the movable rod 32 from being separated from the bottom cover 22, the elastic part 35 is sleeved on the movable rod 32, and both ends thereof are respectively propped against the limit rod 222 and the limit head 321. In the embodiment, the elastic part 35 is a spring. In other embodiments, the water outlet f is in a circular table shape, and the seal 33 is in a circular table shape. The seal 33 can be made of materials such as sealing silicone or sealing rubber. In the embodiment, a base 225 is integrally arranged in the water trough a on the water tray 1, the water trough a arranged between the base 225 and the inner side wall of the water tray 1 is circular, and the water guide slot d is arranged on the base 225. In the embodiment, the height of the base plate is less than the depth of the water trough a to avoid water overflow from the water tray 1.

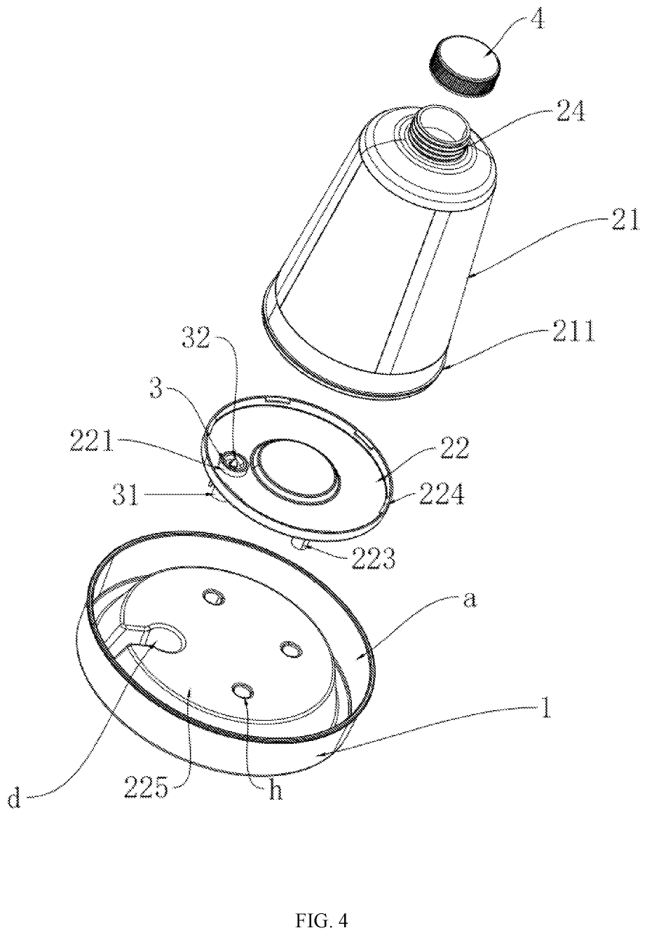

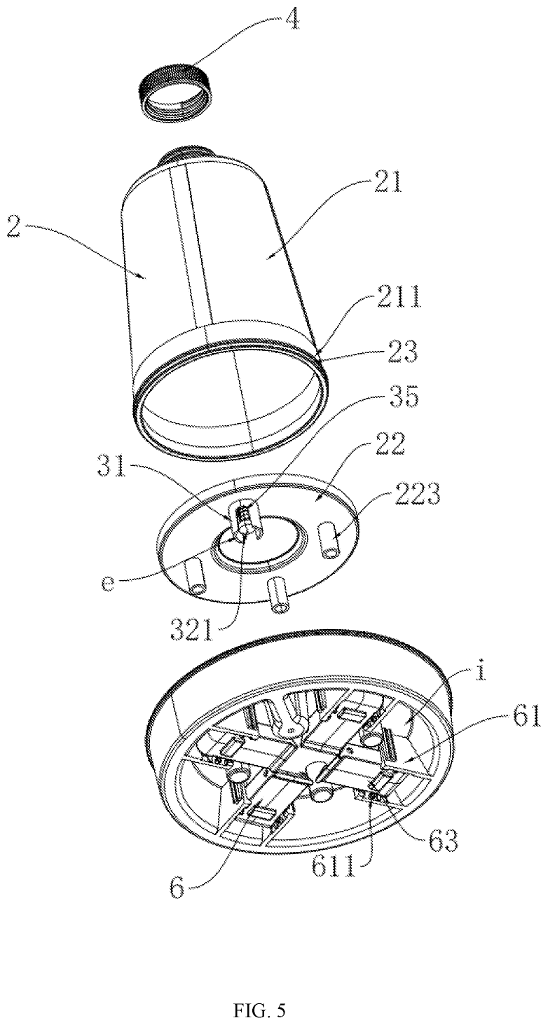

Preferably, to enable the water storage device 2 to be more stably installed on water tray 1 and facilitate the user to assemble or disassemble the water storage device 2 and the water tray 1, as shown in FIG. 4 to FIG. 5, a plurality of plugging columns 223 protrude downward from the bottom of the bottom cover, and a plurality of plugging slots h used for the plugging columns 223 to be plugged one by one are arranged on the base 225. The clearance fit or transition fit is adopted between the plugging columns 223 and the plugging slots h.

Optionally, the bottom cover 22 and the bucket body 21 are removably assembled to facilitate the user to clean the water storage device 2. As shown in FIG. 3 to FIG. 5, a first clamping part 211 is arranged on the outer side wall of the bucket body 21 near the bucket bottom cover 22, a second clamping part 224 capable of being clamped with the first clamping part 211 is arranged on the inner side wall of the bucket bottom cover 22, and a sealing sleeve 23 for sealing the bucket body 21 and the bucket bottom cover 22 is sleeved on the edge of the bottom opening of the bucket body 21. In the embodiment, the sealing sleeve 23 is made of sealing silicone or sealing rubber. A plurality of second clamping parts 224 protrude, and are clamped with the first clamping parts 211. In the embodiment, the first clamping parts 211 are arranged annularly on the outer side wall of the bucket body 21. In other embodiments, the first clamping parts 211 protrude outwards and are arranged on the outer side wall of the bucket body 21, a plurality of first clamping part 211 are arranged, and the second clamping parts 224 are clamping slots arranged on the inner side wall of the bucket bottom cover 22 and corresponding to the first clamping parts 211 one to one.

Preferably, to facilitate the user to fill water, as shown in FIG. 1 to FIG. 5, the water inlet b is arranged on the top of the bucket body 21, so that the user fills water into the water feeder without removal of the water storage device 2 from the water tray 1, just fill water directly into the water inlet b, making filling more convenient, and reducing the output of the physical strength; the poultry water feeder also comprises a cover body 4 covered on the water inlet b to prevent external dust from entering into the bucket body 21 through the water inlet b. In the embodiment, a water inlet part 24 is arranged on the top of the bucket body 21, the water inlet hole runs through the water inlet part 24, the cover body 4 is connected with the water inlet b through a thread, and a sealing gasket 5 is arranged between the cover body 4 and the water inlet b. In the embodiment, the sealing gasket 5 is made of sealing silicone or sealing rubber, and water leaks from the cover body 4 and the water inlet b when the cover body 4 is covered on the water inlet b.

Preferably, as shown in FIG. 4 and FIG. 5, to facilitate the user to adjust the height of the water feeder according to the height of the poultry, a plurality of supporting legs 6 which can adjust the height of the water tray 1 are arranged at the bottom of the water tray 1. It should be noted that an assembly groove i is arranged in the downward direction of the base 225. In the embodiment, each group of supporting legs 6 comprises an assembly part 61, a first supporting leg 62 and a second supporting leg 63. The assembly part 61 is arranged in the assembly groove i, and a limit groove is arranged on the assembly part 61; one end of the first supporting leg 62 is located in the limit groove, is hinged with the inner side wall of the assembly part 61 and can be accommodated in the limit groove, a holding slot is arranged on the first supporting leg 62, and the opening direction of the holding slot is the same as that of the limit groove; one end of the second supporting leg 63 is hinged with one end of the first supporting leg away from the assembly part 61 and can be accommodated in the holding slot. In the embodiment, a limit bump 611 is arranged on the bottom edge of the assembly groove i, limits the first supporting leg in the assembly groove i to prevent the first supporting leg from leaving the assembly groove i under the action of the gravity, and can be semicircular, semielliptical or cambered. In other embodiments, each group of supporting legs 6 comprises an assembly part 61 and a telescopic leg, the assembly part 61 protrudes downward in the assembly groove i, is provided with a telescopic groove from the bottom up, the telescopic leg is movably assembled in the telescopic groove, and the telescopic leg and the telescopic groove can be connected through threads; in some embodiments, the telescopic leg and the telescopic groove are adjusted through a ball screw and a locating slot. In the embodiment, one or more telescopic legs are arranged, and multiple telescopic legs are sleeved with each other, and the two adjacent telescopic legs are connected through threads or ball screws and locating holes.

The above is only used to describe the technical proposal of the utility model and not to limit it, and other modifications or equivalent replacements made by the ordinary technicians in the field to the technical proposal of the utility model should be covered in the scope of claims of the utility model as long as they do not deviate from the spirit and scope of the technical proposal of the utility model.

1. A poultry water feeder, comprising a water tray (1) and a water storage device (2) on which the water tray (1) is removably installed, wherein a water trough (a) is arranged on the water tray (1), a water inlet (b) is arranged on the water storage device (2), and characterized in that the water storage device (2) comprises a bucket body (21) and a bucket bottom cover (22), a water outlet hole (c) connected with the water trough (a) is arranged on the bucket bottom cover (22), and the poultry water feeder also comprises a sealing component (3), one part of which is arranged on the bucket bottom cover (22) and the other part of which is arranged on the water tray (1) for opening or sealing the water outlet hole (c).

2. The poultry water feeder according to claim 1, characterized in that a water guide slot (d) connected with the water outlet hole (c) and the water trough (a) is arranged under the water outlet hole (c) of the water tray (1), the sealing component (3) comprises a plugging part (31) arranged at the bottom of the bucket bottom cover (22), located at the bottom of the water outlet hole (c) and capable of being plugged in the water guide slot (d), a movable rod (32) arranged in a movable hole (e) and with one end extending into the water outlet hole (c), a seal (33) located on the top of the movable rod (32) and used for sealing with or separating from the water outlet hole (c) under the drive of the movable rod (32), a propping part (34) arranged in the water guide slot (d) and capable of propping against the movable rod (32) to separate the seal (33) from the water outlet hole (c), and an elastic part (35) arranged in the movable hole (e) and with both ends connected with the bottom of the movable rod (32) and the bottom of the bucket bottom cover (22) respectively, and the movable hole (e) connected with the water outlet hole (c) is arranged on the plugging part (31);

3. The poultry water feeder according to claim 2, characterized in that a limit part (221) is arranged on the top of the water outlet hole (c) of the bucket bottom cover (22), a water outlet (f) connected with the water outlet hole (c) and capable of sealing with or separating from the outer side wall of the seal (33) is arranged on the limit part (221), a plurality of limit rods (222) are arranged between the water outlet (f) and the movable hole (e) on the bucket bottom cover (22), and a through hole (g) connected with the water outlet (f) and the movable hole (e) is arranged between the two adjacent limit rods (222);

4. The poultry water feeder according to claim 3, characterized in that a limit head (321) with a diameter greater than that of the water outlet hole (c) is arranged at one end of the movable rod (32) away from the water outlet hole (c), the elastic part (35) is sleeved on the movable rod (32), and both ends thereof are respectively propped against the limit rod (222) and the limit head (321);

5. The poultry water feeder according to claim 4, characterized in that a base (225) is integrally arranged in the water trough (a) on the water tray (1), the water trough (a) arranged between the base (225) and the inner side wall of the water tray (1) is circular, and the water guide slot (d) is arranged on the base (225);

6. The poultry water feeder according to claim 5, characterized in that a plurality of plugging columns (223) protrude downward at the bottom of the bottom cover, and a plurality of plugging slots (h) used for the plugging columns (223) to be plugged one by one are arranged on the base (225);

7. The poultry water feeder according to claim 1, characterized in that a first clamping part (211) is arranged on the outer side wall of the bucket body (21) near the bucket bottom cover (22), a second clamping part (224) capable of being clamped with the first clamping part (211) is arranged on the inner side wall of the bucket bottom cover (22), and a sealing sleeve (23) for sealing the bucket body (21) and the bucket bottom cover (22) is sleeved on the edge of the bottom opening of the bucket body (21);

8. The poultry water feeder according to claims 1-7, characterized in that the water inlet (b) is arranged on the top of the bucket body (21), and the poultry water feeder also comprises a cover body (4) covered on the water inlet (b);

9. The poultry water feeder according to claim 8, characterized in that the cover body (4) is connected with water inlet (b) through a thread, and a sealing gasket (5) is arranged between the cover body (4) and the water inlet (b);

10. The poultry water feeder according to claim 7, characterized in that a plurality of supporting legs (6) capable of adjusting the height of the water tray (1) are arranged at the bottom of the water tray (1) at intervals.
